(19) United States
(12) Patent Application Publication
(10) Pub. No.: US 2023/0376315 A1
(43) Pub. Date: Nov. 23, 2023

(54) INFORMATION PROCESSING DEVICE AND SEARCH METHOD

(71) Applicant: Fujitsu Limited, Kawasaki-shi (JP)

(72) Inventors: Koji KURIHARA, Kawasaki (JP); Kentaro KAWAKAMI, Kawasaki (JP)

(73) Assignee: Fujitsu Limited, Kawasaki-shi (JP)

(21) Appl. No.: 18/110,607

(22) Filed: Feb. 16, 2023

(30) Foreign Application Priority Data
May 18, 2022 (JP) 2022-081396

(51) Int. Cl. G06F 9/38; G06F 9/30

(52) U.S. Cl. CPC G06F 9/3887; G06F 9/3001

(57) ABSTRACT

A non-transitory computer-readable recording medium stores a program for causing a computer to execute a process, the process includes, in a search for combinations of conditions that allow extraction of sample data groups that have n or more attribute pairs whose correlation coefficients exceed a threshold value, when a number of combinations of the conditions is equal to or greater than a number capable of being parallelized, parallelizing processing for the combinations of the conditions per the number capable of being parallelized to calculate the correlation coefficients of respective attribute pairs for each of the combinations of the conditions in addition to a single instruction multiple data (SIMD) conversion process that uses predicate registers as many as the number capable of being parallelized, and searching for the combinations of conditions using the correlation coefficients of the respective attribute pairs for each of the combinations of the conditions.

### CROSS-REFERENCE TO RELATED APPLICATION

This application is based upon and claims the benefit of priority of the prior Japanese Patent Application No. 2022-81396, filed on May 18, 2022, the entire contents of which are incorporated herein by reference.

### FIELD

The embodiments discussed herein is related to an information processing device and a search method.

### BACKGROUND

In recent years, research has been conducted to efficiently narrow down the number of conditions to be causally searched, by extracting correlated conditions. FIG. 17 is a diagram illustrating condition extraction for statistical causal search. As illustrated in FIG. 17, such a technique extracts all condition candidates for correlated data from past data to be used to train artificial intelligence (AI). Then, in the technique, all conditions for data having a causal relationship are extracted from the extracted condition candidates. However, in the technique, while all condition candidates are searched to find a causal relationship, there is a problem that the search is unrealistic from the viewpoint of the amount of computation.

Thus, a technique that efficiently narrows down the number of conditions to be causally searched, by relaxing the condition search target to the correlation from the causal relationship has been disclosed. FIG. 18 is a diagram illustrating a technique for discovering individual characteristic causal relationships. As illustrated in FIG. 18, this technique first uses an emerging pattern discovery technique to exhaustively find, from a past sample set, a combination of a specific condition and an important factor candidate that has a strong correlation with the objective variable under the specific condition. Note that the past sample set is used after being binarized based on a threshold value.

Thereafter, for each of the found conditions, a causal search technique is used to determine whether the important factor candidate under that condition is accurately an important factor. For example, a case where there is “x1 ∧x3 ∧x4→y” (y=1 when x1=x3=x4=1 is true) is assumed. In such a case, one variable chosen from the left side is assigned as an “important factor candidate”, and the rest is assigned as a “condition”. Here, it is assumed that x4 indicates the “important factor candidate” and the remaining “x1 ∧x3” indicates the “condition”. In this technique, if there is a high correlation between the “important factor candidate” and y on the right side in the past sample set that satisfies the “condition”, that “condition” is adopted. The conditions and important factors found in this manner are held in a database (DB). Then, when applied, for samples whose causal relationships are desired, the conditions that these samples satisfy are selected from the DB, and the corresponding important factors are presented.
Japanese National Publication of International Patent Application No. 2016-537723 is disclosed as related art.
Koyanagi Yusuke, four others, “Developing a Framework for Individual Causal Discovery and its Application to Real Marketing Data”, The Japanese Society for Artificial Intelligence 18th Special Interest Group on Business Informatics, March 2021, <URL: http://sig-bi.jp/doc/18th_SIG-BI_2021/18th_SIG-BI_2021_paper_13.pdf> is also disclosed as related art.

### SUMMARY

According to an aspect of the embodiment, a non-transitory computer-readable recording medium stores a program for causing a computer to execute a process, the process includes, in a search for combinations of conditions that allow extraction of sample data groups that have n (n is a natural number) or more attribute pairs whose correlation coefficients exceed a threshold value, when a number of combinations of the conditions is equal to or greater than a number capable of being parallelized, parallelizing processing for the combinations of the conditions per the number capable of being parallelized to calculate the correlation coefficients of respective attribute pairs for each of the combinations of the conditions in addition to a single instruction multiple data (SIMD) conversion process that uses predicate registers as many as the number capable of being parallelized, and searching for the combinations of the conditions using the correlation coefficients of the respective attribute pairs for each of the combinations of the conditions.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a functional configuration of an information processing device according to an embodiment;

FIG. 2 is a diagram illustrating a single instruction multiple data (SIMD) conversion process;

FIG. 3 is a diagram illustrating an example of a pseudocode for sum computation in the SIMD conversion process;

FIG. 4 is a diagram illustrating an example of a flowchart of a correlation coefficient calculation process when the SIMD conversion process is applied;

FIG. 5 is a diagram illustrating an image of a stream process according to the embodiment;

FIG. 6 is a diagram illustrating an example of a pseudocode for sum computation in the stream process according to the embodiment;

FIG. 7 is a diagram illustrating an image of an unrolling process according to the embodiment;

FIG. 8 is a diagram illustrating an example of a pseudocode for sum computation in the unrolling process according to the embodiment;

FIG. 9 is a diagram illustrating an example of a flowchart of a search process according to the embodiment;

FIG. 10 is a diagram illustrating an example of a flowchart of the correlation coefficient calculation process when the stream process according to the embodiment is applied;

FIG. 11 is a diagram illustrating an example of a flowchart of the correlation coefficient calculation process when the unrolling process according to the embodiment is applied;

FIG. 12 is a diagram illustrating an example of a computer that executes a search program;

FIG. 13A is a diagram (1) illustrating a search method for a combination of conditions;

FIG. 13B is a diagram (2) illustrating the search method for a combination of conditions;

FIG. 13C is a diagram (3) illustrating the search method for a combination of conditions;

FIG. 14 is a diagram illustrating a pseudocode for the correlation coefficient calculation process;

FIG. 15A is a diagram (1) illustrating supplementation for the correlation coefficient calculation process;

FIG. 15B is a diagram (2) illustrating supplementation for the correlation coefficient calculation process;

FIG. 16 is a diagram illustrating an example of a flowchart of the correlation coefficient calculation process;

FIG. 17 is a diagram illustrating condition extraction for statistical causal search; and

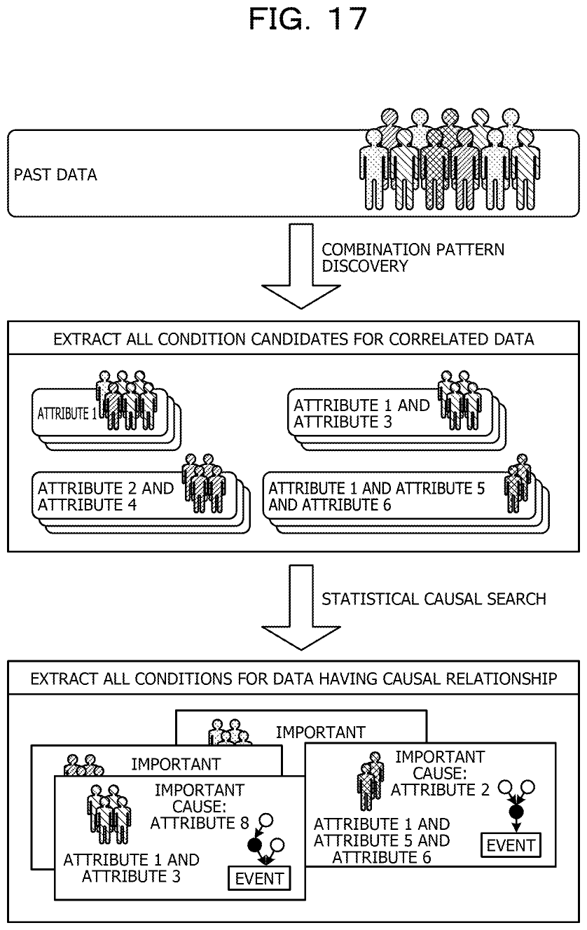

FIG. 18 is a diagram illustrating a technique for discovering individual characteristic causal relationships.

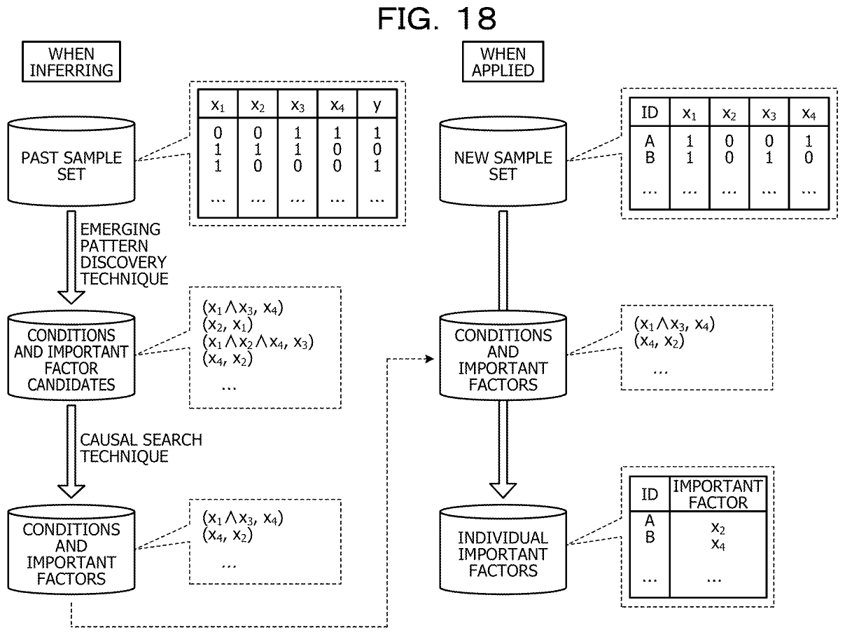

### DESCRIPTION OF EMBODIMENT

When the condition for extracting the past sample set is adopted, a correlation coefficient is calculated between the “important factor candidate” and y on the right side of the above-described proposition. Therefore, it is desirable to calculate the correlation coefficient efficiently.

Hereinafter, an embodiment of an information processing device and a search method disclosed in the present application will be described in detail with reference to the drawings. Note that the present disclosure is not limited to the embodiment.

### Embodiment

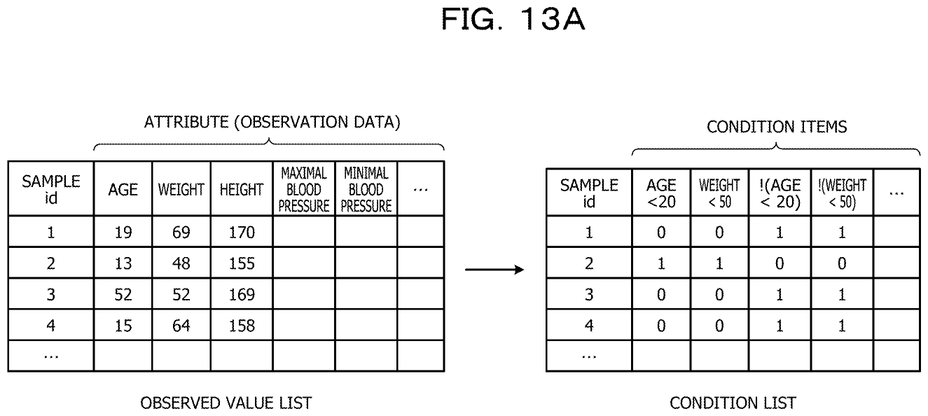

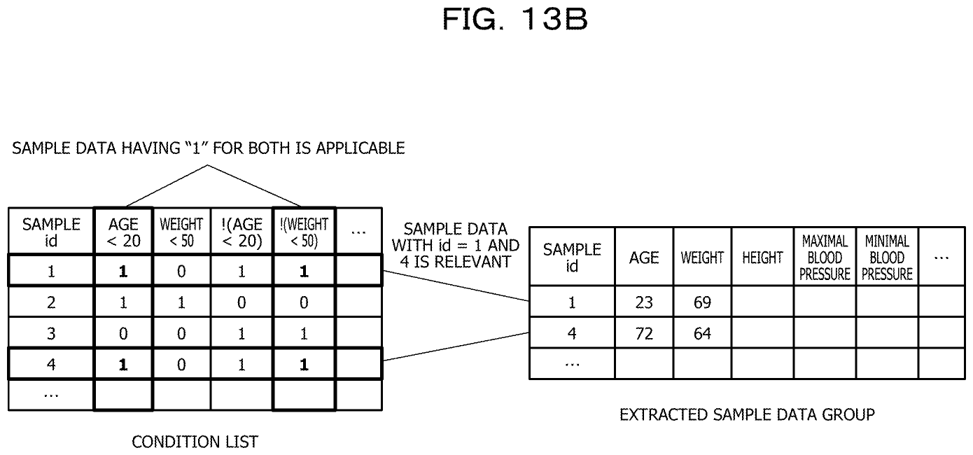

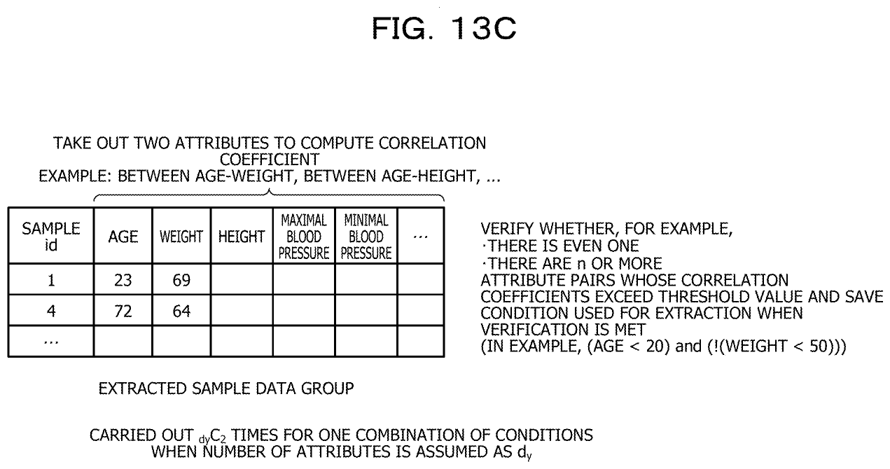

First, when there are sample data groups for a plurality of attributes observed with respect to individual samples, searching for a combination of condition items for extracting a sample set having, for example, n or more attribute pairs whose correlation coefficients exceed a threshold value will be considered. FIGS. 13A to 13C are diagrams explaining a search method for a combination of conditions.

The left diagram of FIG. 13A represents an observed value list. The observed value list is a list that stores a numerical data group of a plurality of observed values (attributes) observed for a sample id. The right diagram of FIG. 13A represents a condition list. The condition list is a list of conditions for extracting sample sets “having correlated attribute pairs”. The conditions are generated from, for example, the observed values (attributes) but are not limited to this. Since the conditions are intended for an exhaustive search, a not condition is included for every single condition. Here, when the single condition is “age<20”, “!(age<20)” is stored as the not condition.

As illustrated in FIG. 13B, a combination of conditions is created by taking out k conditions from among all conditions in the condition list. Here, a case where k is “2” is treated, and the combination of conditions is “(age<20) and (!(weight<50))” indicating the logical product of “age<20” and “!(weight<50)”. The search process extracts sample data groups in which combined conditions all have “1”. For example, the search process extracts sample data groups that satisfy the condition of “(age<20) and (!(weight<50))”.

FIG. 13C represents the extracted sample data groups. The search process takes out two attributes from each of the extracted sample data groups and computes the correlation coefficient for the attribute pair that has been taken out. For example, the age attribute and the weight attribute are taken out, and the correlation coefficient between the age and the weight is computed. The age attribute and the height attribute are taken out, and the correlation coefficient between the age and the height is computed. Then, the search process determines, for example, whether there are n or more attribute pairs whose correlation coefficients exceed the threshold value and saves the combination of conditions used for the extraction when the determination is satisfied. Here, one condition that satisfies the determination is “(age<20) and (!(weight<50))”.

The search for combinations of conditions is carried out a number of times equal to _{dx}Cₖ patterns, where the number of all conditions is assumed as dx and the number of conditions to be combined is assumed as k. When the number of all conditions dx and the number of conditions k to be combined become larger, the number of combinations of conditions to be searched increases explosively. For example, the search process extracts sample data groups that satisfy the conditions for each combination of conditions and calculates the correlation coefficients of the attribute pairs for the extracted sample data groups. Then, the search process searches for a combination of conditions that derives n or more attribute pairs whose correlation coefficients exceed the threshold value. Therefore, in order to deal with a large-scale number of all conditions dx, it is practically expected to parallelize the search process and speed up the processing of each arithmetic operation.

In the search process, the processing of calculating the correlation coefficients of the attribute pairs in the extracted sample data groups takes a very long time. The correlation coefficient calculation process calculates a correlation coefficient R_{y12} using following formulas (1) to (4) when calculating the correlation coefficient between two attributes Y₁ and Y₂. Note that data of an attribute Y₁ whose sample id is i in the extracted sample data groups is meant by Y_{1,i}. Data of an attribute Y₂ whose sample id is i in the extracted sample data groups is meant by Y_{2,i}. An average value of data corresponding to the attribute Y₁ in the extracted sample data groups is denoted by Y₁ₐᵥₑ. An average value of data corresponding to the attribute Y₂ in the extracted sample data groups is denoted by Y₂ₐᵥₑ.

$${S}_{{y}_{12}} = Σ ( {Y}_{1 , i} - {Y}_{{1}_{ave}} ) ( {Y}_{2 , i} - {{Y}_{2}}_{ave} ) \qquad ( 1 )$$

$${S}_{{y}_{1}} = {Σ ( {Y}_{1 , i} - {Y}_{{1}_{ave}} )}^{2} \qquad ( 2 )$$

$${S}_{{y}_{2}} = {Σ ( {Y}_{2 , i} - {Y}_{{2}_{ave}} )}^{2} \qquad ( 3 )$$

$${R}_{{y}_{12}} = \frac{\vert {S}_{{y}_{12}} \vert}{\sqrt{{S}_{{y}_{1}}} \times \sqrt{{S}_{{y}_{2}}}} \qquad ( 4 )$$

Assuming that the number of attributes is dy when searching for one combination of conditions, the correlation coefficient calculation process will carry out these formulas (1) to (4) _{dy}C₂ times.

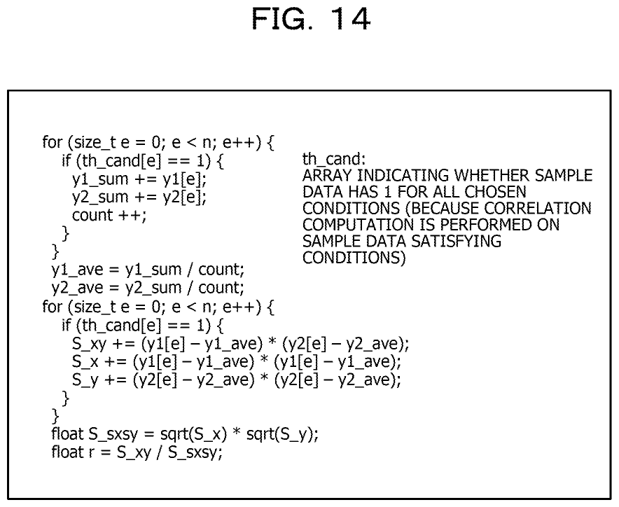

FIG. 14 is a diagram illustrating a pseudocode for the correlation coefficient calculation process. The symbol y1_ave illustrated in FIG. 14 corresponds to Y₁ₐᵥₑ. The symbol y2_ave corresponds to Y₂ₐᵥₑ. The symbol S_xy corresponds to S_{y12}. The symbol S_x corresponds to S_{y1}. The symbol S_y corresponds to S_{y2}. The symbol r corresponds to R_{y12}. In addition, the symbol th_cand denotes an array indicating whether or not the selected combination condition has “1”, for each of n pieces of sample data included in the observed value list.

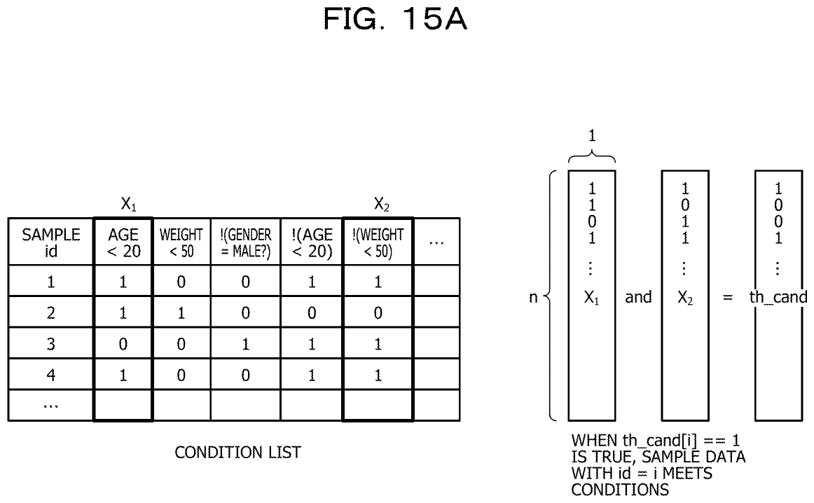

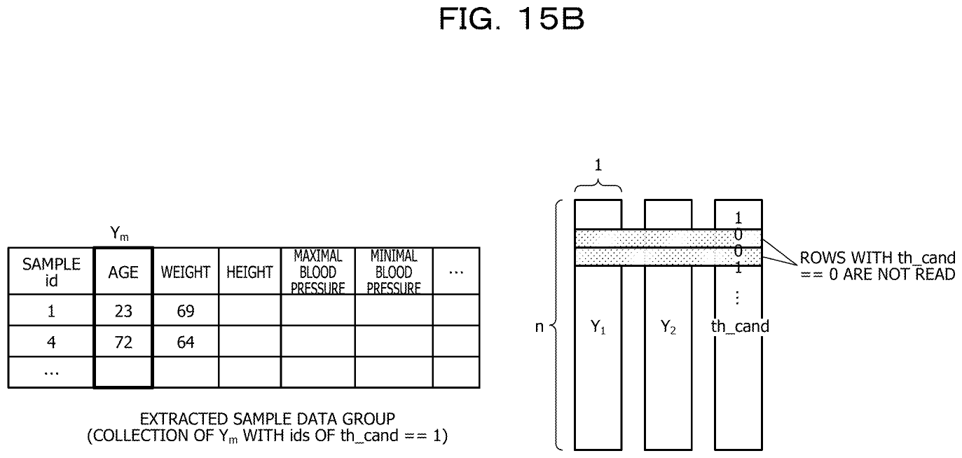

The array th_cand is found by computing the bitwise and for the combination of conditions. FIGS. 15A and 15B are diagrams illustrating supplementation for the correlation coefficient calculation process. The left diagram of FIG. 15A represents the condition list. Here, it is assumed that the bit string indicating the condition “age<20” is denoted by X₁, and the bit string indicating the condition “!(weight<50)” is denoted by X₂. Then, th_cand is calculated by conducting an and logical operation between X₁ and X₂. Note that, when th_cand[i] has “1”, it means that the sample data whose sample id indicates “i” is data that meets the combination condition.

The left diagram of FIG. 15B represents sample data groups extracted for the combination condition. For example, the extracted sample data groups are the data groups of the sample ids whose th_cand indicates “1”. For example, the data extracted when the attribute is “age” is represented by Yₘ. The correlation coefficients of respective attribute pairs are calculated for the combination conditions, using the extracted sample data groups.

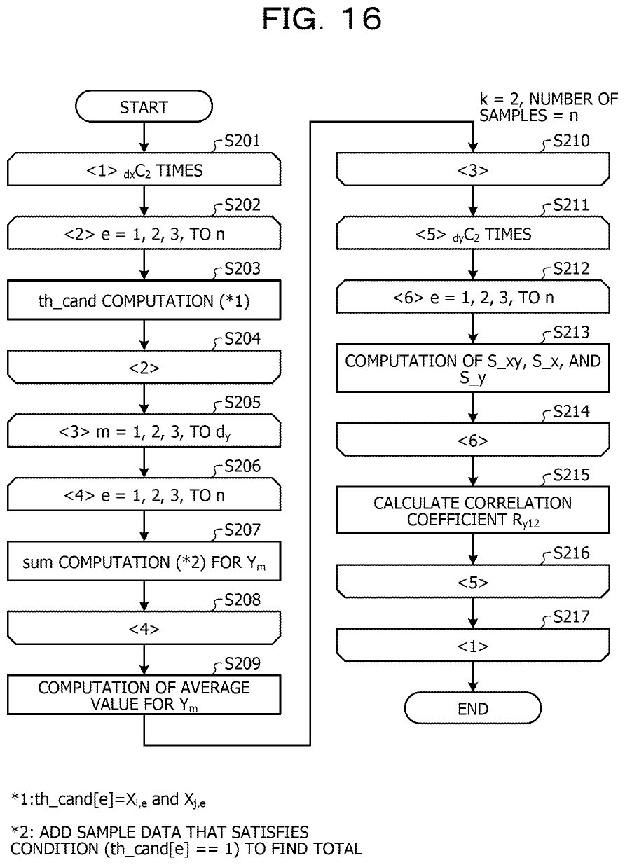

Here, a processing flow of the correlation coefficient calculation process will be described with reference to FIG. 16. FIG. 16 is a flowchart illustrating a processing flow of the correlation coefficient calculation process. Note that the number of all conditions is assumed as dx. The number of conditions k to be combined is assumed to be two. The total number of sample ids is assumed as n. The number of attribute columns is assumed as d_{y}.

As illustrated in FIG. 16, the correlation coefficient calculation process takes out two conditions from among all conditions and repeats steps S202 to S217 _{dx}C₂ times (step S201).

The correlation coefficient calculation process repeats steps S203 and S204 until an index e of the th_cand array has the total number of sample ids n starting from one (step S202). The correlation coefficient calculation process performs a th_cand computation process (step S203). For example, the correlation coefficient calculation process sets the result of computing “X_{i,e} and X_{j,e}” in th_cand[e]. Here mentioned X_{i,e} and X_{j,e} indicate bits of the index e for the conditions Xᵢ and Xⱼ. The correlation coefficient calculation process proceeds to step S202 to process the next index e (step S204).

Subsequently, the correlation coefficient calculation process repeats steps S206 to S210 until an index m indicating the attribute has the number of attribute columns d_{y} starting from one (step S205). Then, the correlation coefficient calculation process repeats steps S207 and S208 until the index e of the th_cand array has the total number of sample ids n starting from one (step S206). The correlation coefficient calculation process performs sum computation for the attribute column Yₘ (step S207). For example, the correlation coefficient calculation process computes the total (sum) by adding the e-th value of the attribute column Yₘ that satisfies the condition (th_cand[e]=“1”). The correlation coefficient calculation process proceeds to step S206 to process the next index e (step S208).

Subsequently, the correlation coefficient calculation process computes the average value of the attribute column Yₘ (step S209). Then, the correlation coefficient calculation process proceeds to step S205 to process the next attribute (step S210).

Subsequently, the correlation coefficient calculation process takes out two attribute columns from among all attribute columns and repeats the processing in steps S212 to S216 _{dy}C₂ times (step S211). The correlation coefficient calculation process repeats steps S213 and S214 until the index e of the th_cand array has the total number of sample ids n starting from one (step S212). The correlation coefficient calculation process computes S_xy, S_x, and S_y (step S213). For example, the correlation coefficient calculation process computes S_xy, S_x, and S_y, using the e-th value of the attribute column Yₘ that satisfies the condition (th_cand[e]=“1”). Formula (1) corresponds to S_xy here mentioned. Formula (2) corresponds to S_x. Formula (3) corresponds to S_y. Then, the correlation coefficient calculation process proceeds to step S212 to process the next index e (step S214).

Subsequently, the correlation coefficient calculation process calculates the correlation coefficient R_{y12} between the two attribute columns that have been taken out (step S215). Formula (4) corresponds to R_{y12} here mentioned. Then, the correlation coefficient calculation process proceeds to step S211 to take out next two attribute columns (step S216).

The correlation coefficient calculation process then proceeds to step S201 to take out next two conditions (step S217).

In this manner, the search for combinations of conditions is carried out a number of times equal to _{dx}Cₖ patterns, where the number of all conditions is assumed as dx and the number of conditions to be combined is assumed as k (<1>). When the number of all conditions dx and the number of conditions k to be combined become larger, the number of combinations of conditions to be searched increases explosively. For example, for a number of times equal to the _{dx}Cₖ patterns, the search process extracts sample data groups that satisfy the conditions for each combination of conditions and calculates the correlation coefficient of the attribute pair for the extracted sample data groups. Then, the search process will search for a combination of conditions that derives n or more attribute pairs whose correlation coefficients exceed the threshold value. Therefore, in order to deal with a large-scale number of all conditions dx, it is practically expected to achieve speeding up of the processing of extracting sample data groups that satisfy the conditions and the processing of calculating the correlation coefficients of the attribute pairs in the extracted sample data groups.

Thus, in the following embodiment, an information processing device that speeds up the processing of extracting sample data groups that satisfy the conditions and the processing of calculating the correlation coefficients of the attribute pairs in the extracted sample data groups will be described.

[Configuration of Information Processing Device]

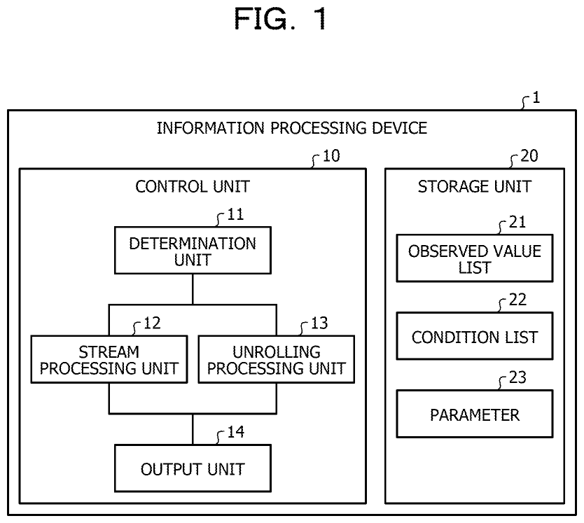

FIG. 1 is a functional diagram illustrating a configuration of the information processing device according to an embodiment. In searching for a combination of conditions, the information processing device 1 conducts single instruction multiple data (SIMD) conversion for the processing of extracting sample data groups and the processing of calculating the correlation coefficients of the attribute pairs in the extracted sample data groups. Furthermore, by selecting and using parallel processing (stream process) or an unrolling process according to the number of combinations of conditions, the information processing device 1 speeds up the processing of extracting sample data groups and the processing of calculating the correlation coefficients of the attribute pairs in the extracted sample data groups.

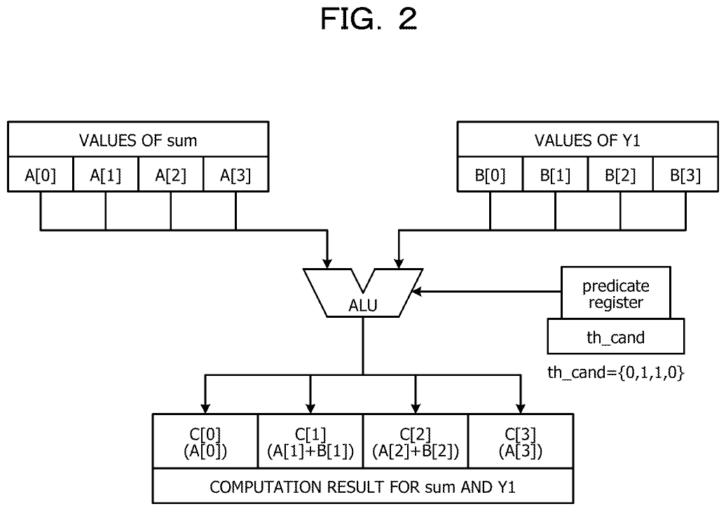

Here, a SIMD conversion process will be described with reference to FIG. 2. FIG. 2 is a diagram illustrating the SIMD conversion process. Note that SIMD registers are denoted by each of A[0], . . . , and B[0], . . . . A predicate register is used in order to conduct the SIMD conversion for the processing. By using the value of th_cand as the value of the predicate register, the information processing device 1 is allowed to simultaneously process a number of data operations equal to the SIMD width, using an arithmetic and logic unit (ALU). Although the two SIMD registers A and B are mounted in FIG. 2, the number of SIMD registers A and B is defined depending on a central processing unit (CPU). Note that th_cand mentioned here indicates an array in which “1” is set if the combination condition is satisfied and “0” is set if the combination condition is not satisfied, for each of the n pieces of sample data included in an observed value list 21, which will be described later.

For example, in FIG. 2, sum computation corresponding to a certain attribute for a sample data group that satisfies a combination condition is performed. When th_cand has “0110 . . . ”, th_cand is given to the predicate register. A plurality of (here, four) sample data values corresponding to the attribute is input to the SIMD register B at a time. Then, since the operation is masked by the bit string of th_cand, the information processing device 1 is allowed to simultaneously process the addition of the sample data values satisfying the combination condition.

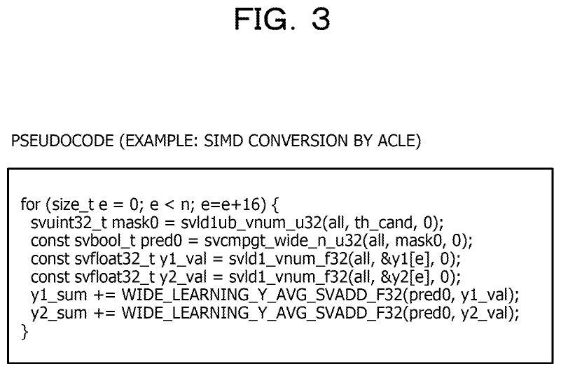

FIG. 3 is a diagram illustrating an example of a pseudocode for sum computation in the SIMD conversion process. Note that the pseudocode is a code for SIMD conversion by ARM C Language Extensions (ACLE) for ARM. In FIG. 3, illustrated th_cand is an array in which “1” is set if the combination condition is satisfied and “0” is set if the combination condition is not satisfied, for each of the n pieces of sample data included in the observed value list 21, which will be described later. A variable used for the sum computation of one attribute of the attribute pair for which the correlation coefficient is to be found is denoted by y1_sum. A variable used for the sum computation of the other attribute of the attribute pair for which the correlation coefficient is to be found is denoted by y2_sum.

Here, a case where the processing target sample data is of float type (32 bits) and the SIMD width is 512 bits is assumed. Then, the SIMD registers A and B illustrated in FIG. 2 are mounted as 16 pieces each. Accordingly, the information processing device 1 uses the predicate register for each attribute of the attribute pair to simultaneously add 16 pieces at a time for each attribute of the attribute pair. This allows the information processing device 1 to reduce the number of loop rotations to 1/16 for each attribute of the attribute pair. As a result, the information processing device 1 may be made faster than sequentially performing addition for each attribute of the attribute pair.

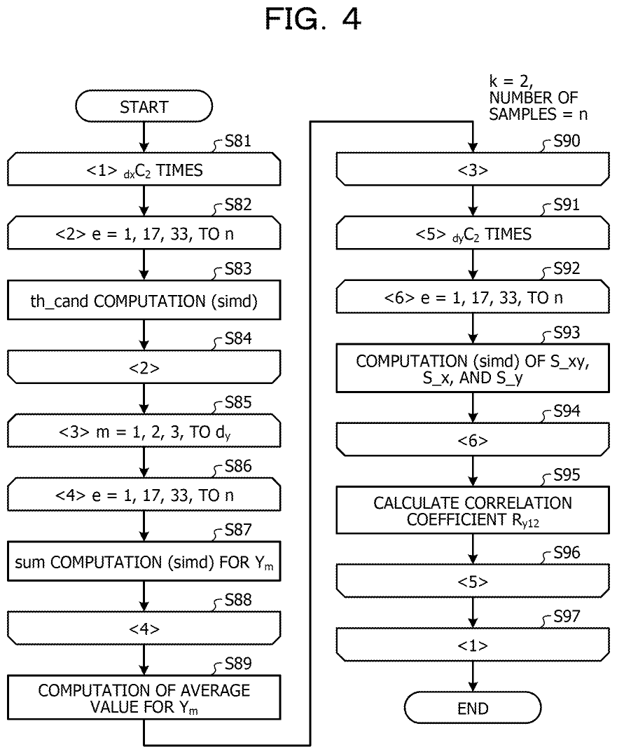

The SIMD conversion illustrated in FIG. 3 relates to an example of sum computation but may also be applied to the correlation coefficient calculation process including th_cand computation of generating th_cand. FIG. 4 is a diagram illustrating an example of a flowchart of the correlation coefficient calculation process when the SIMD conversion process is applied. Note that the number of all conditions is assumed as dx. The number of conditions k to be combined is assumed to be two. The total number of sample ids is assumed as n. The number of attribute columns is assumed as d_{y}. In addition, a case where the data type of the sample data is the float type (32 bits) and the SIMD width is 512 bits is assumed.

As illustrated in FIG. 4, the correlation coefficient calculation process takes out two conditions from among all conditions and repeats the processing in steps S82 to S97 _{dx}C₂ times (step S81).

The correlation coefficient calculation process repeats steps S83 and S84 with an increment value of 16 until the index e of the th_cand array has the total number of sample ids n starting from one (step S82). The correlation coefficient calculation process performs a th_cand computation (simd) process (step S83). For example, the correlation coefficient calculation process computes “X_{i,e} and X_{j,e}” for the indices e to e+15 and sets the computed result in th_cand[e]. Here mentioned X_{i,e} and X_{j,e} indicate bits of the index e for the conditions Xᵢ and Xⱼ. The correlation coefficient calculation process proceeds to step S82 to process the next index e (step S84).

Subsequently, the correlation coefficient calculation process repeats steps S86 to S90 until the index m indicating the attribute has the number of attribute columns d_{y} starting from one (step S85). Then, the correlation coefficient calculation process repeats steps S87 and S88 with an increment value of 16 until the index e of the th_cand array has the total number of sample ids n starting from one (step S86). The correlation coefficient calculation process performs sum computation (simd) for the attribute column Yₘ (step S87). For example, the correlation coefficient calculation process performs addition for the attribute column Yₘ that satisfies the condition (th_cand[e]=“1”), by 16 pieces at a time, and computes the total (sum) by adding each value of the indices e to e+15. The correlation coefficient calculation process proceeds to step S86 to process the next index e (step S88).

Subsequently, the correlation coefficient calculation process computes the average value of the attribute column Yₘ (step S89). Then, the correlation coefficient calculation process proceeds to step S85 to process the next attribute (step S90).

Subsequently, the correlation coefficient calculation process takes out two attribute columns from among all attribute columns and repeats the processing in steps S92 to S96 _{dy}C₂ times (step S91). The correlation coefficient calculation process repeats steps S93 and S94 with an increment value of 16 until the index e of the th_cand array has the total number of sample ids n starting from one (step S92). The correlation coefficient calculation process computes (simd) S_xy, S_x, and S_y (step S93). For example, the correlation coefficient calculation process computes S_xy, S_x, and S_y, using the values of the indices e to e+15 of the attribute column Yₘ that satisfy the condition (th_cand[e]=“1”). Formula (1) corresponds to S_xy here mentioned. Formula (2) corresponds to S_x. Formula (3) corresponds to S_y. Then, the correlation coefficient calculation process proceeds to step S92 to process the next index e (step S94).

Subsequently, the correlation coefficient calculation process calculates the correlation coefficient R_{y12} between the two attribute columns that have been taken out (step S95). Formula (4) corresponds to R_{y12} here mentioned. Then, the correlation coefficient calculation process proceeds to step S91 to take out next two attribute columns (step S96).

The correlation coefficient calculation process then proceeds to step S81 to take out next two conditions (step S97).

This allows the information processing device 1 to reduce the number of loop rotations to 1/16 because, when SIMD conversion is applied, the processing in the loops of the th_cand computation (<2>), the sum computation (<4>), and the correlation coefficient computation (<6>) is performed collectively by 16 elements at a time. As a result, the information processing device 1 may be made faster than sequentially processing.

FIGS. 2 to 4 are examples of SIMD conversion of processing for one combination of conditions using one predicate register. A plurality of predicate registers may be mounted, and a surplus predicate register may be used for SIMD conversion of processing for a plurality of combinations of conditions such that further speeding up is achieved.

Returning to FIG. 1, the information processing device 1 includes a control unit 10 and a storage unit 20. The control unit 10 includes a determination unit 11, a stream processing unit 12, an unrolling processing unit 13, and an output unit 14. The storage unit 20 includes the observed value list 21, a condition list 22, and parameters 23. Note that the stream processing unit 12 and the unrolling processing unit 13 are examples of a calculation unit and a search unit.

The observed value list 21 is a list that stores numerical data groups of a plurality of observed values observed for each sample id. For example, the observed value list 21 is tabular data in which the values of a plurality of observed values (attributes) for each sample id are accumulated. The sample id mentioned here refers to an identifier that uniquely identifies an individual person or the like. Each column of the observed value list 21 corresponds to each of the observed values (attributes).

The condition list 22 is a list of conditions for extracting sample sets “having correlated attribute pairs”. For example, the condition list 22 is tabular data obtained from the observed value list 21 by binarizing the values of a plurality of observed values (attributes) for each sample id, based on the conditions. For example, the column-wise arrays of the condition list 22 form bit strings for each condition. The conditions are generated from, for example, the observed values but are not limited to this. In addition, since the conditions are intended for an exhaustive search, a not condition is included for every single condition.

The parameters 23 are parameters used when the search process is executed. The parameters 23 include, for example, the number of conditions to be combined, the number of predicate registers, which will be described later, and the like.

The determination unit 11 determines whether or not the number of combinations of conditions is equal to or greater than a number that allows the parallel processing (stream process). The number that allows the parallel processing (stream process) mentioned here indicates, for example, the number of predicate registers. When the number of combinations of conditions is equal to or greater than the number that allows the parallel processing (stream process), the determination unit 11 passes the processing to the stream processing unit 12. When the number of combinations of conditions is less than the number that allows the parallel processing (stream process), the determination unit 11 passes the processing to the unrolling processing unit 13. Note that the number that allows the parallel processing (stream process) will be assumed hereinafter to be also referred to as the number of streams.

The stream processing unit 12 performs SIMD conversion using a number of predicate registers equal to the number that allows the parallel processing (stream process). Additionally, the stream processing unit 12 conducts the parallel processing (stream process) for a number of combinations of conditions equal to the number that allows the parallel processing (stream process) to calculate the correlation coefficients of a plurality of attribute pairs for each combination of conditions. The stream processing unit 12 then uses each of the correlation coefficients of the plurality of attribute pairs for each combination of conditions to search for a combination of conditions that derives n or more attribute pairs whose correlation coefficients exceed the threshold value. Then, the stream processing unit 12 saves the combination of conditions that derives n or more attribute pairs whose correlation coefficients exceed the threshold value.

The unrolling processing unit 13 performs SIMD conversion using a surplus predicate register. Additionally, the unrolling processing unit 13 calculates the correlation coefficients of the plurality of attribute pairs for each combination of conditions with an unrolling process of unrolling the processing for one combination of conditions into a plurality of units. The unrolling processing unit 13 then uses each of the correlation coefficients of the plurality of attribute pairs for each combination of conditions to search for a combination of conditions that derives n or more attribute pairs whose correlation coefficients exceed the threshold value. Then, the unrolling processing unit 13 saves the combination of conditions that derives n or more attribute pairs whose correlation coefficients exceed the threshold value.

The output unit 14 outputs the combination of conditions that derives n or more attribute pairs whose correlation coefficients exceed the threshold value.

[Description of Stream Process]

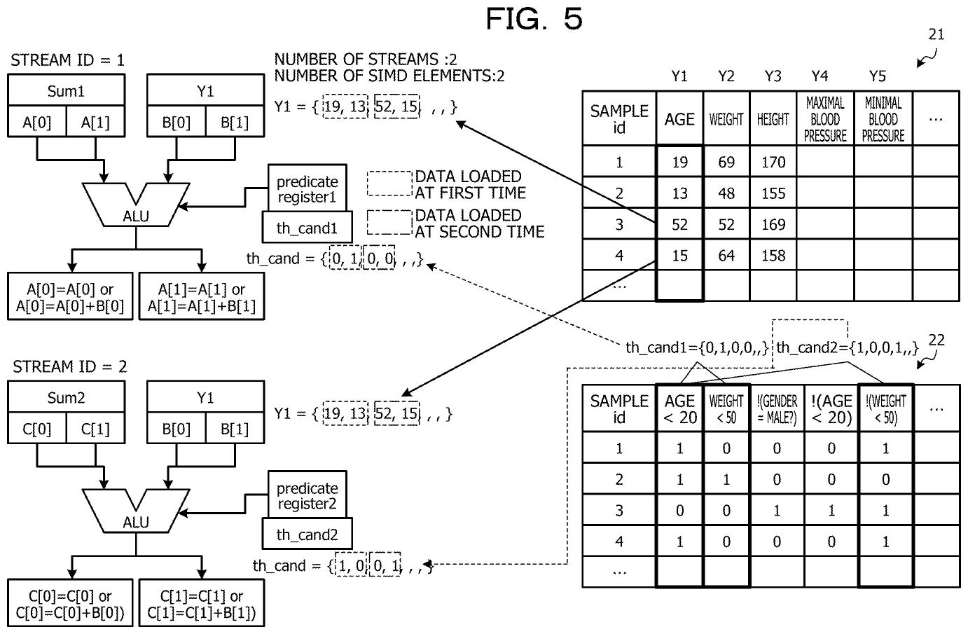

Here, the explanation of the stream process performed by the stream processing unit 12 will be described with reference to FIG. 5. FIG. 5 is a diagram illustrating an image of the stream process according to the embodiment. Note that, in FIG. 5, it is assumed that the number of streams is “2” and the number of SIMD elements (the number of elements of each of SIMD registers A, B, and C) is “2”.

When the stream identifier (ID) is “1”, the combination of conditions is “(age<20) and (weight<50)” indicating the logical product of “age<20” and “weight<50”. The bit string for the combination condition indicated by th_cand1 is {0, 1, 0, 0, . . . }. When the stream ID is “2”, the combination of conditions is “(age<20) and (!(weight<50))” indicating the logical product of “age<20” and “!(weight<50)”. The bit string for the combination condition indicated by th_cand2 is {1, 0, 0, 1, . . . }.

A case where the stream processing unit 12 performs sum computation for the attribute column Y₁ for each combination of conditions under such circumstances will be described. The stream processing unit 12 inputs the values placed in Y₁ to the SIMD register B by the number of SIMD elements (here, two) at a time and performs sum computation for the stream IDs “1” and “2” in parallel.

For example, when the stream ID is “1”, the stream processing unit 12 inputs the bits placed in th_cand1 to a predicate register 1 by the number of SIMD elements (here, two) at a time. Then, the stream processing unit 12 adds the SIMD registers A and B such that the operations of the elements for which the bits of th_cand1 indicate “0” are masked and the operations of the elements for which the bits of th_cand1 indicate “1” are performed. The SIMD register A is the register on the added side. Here, since “0, 1” is input to the predicate register 1 at the first time, the stream processing unit 12 conducts computation as A[0]=A[0] (=0) and A[1]=A[1]+B[1] (=13). Since “0, 0” is input to the predicate register 1 at the second time, the stream processing unit 12 conducts computation as A[0]=A[0] (=0) and A[1]=A[1] (=13). In this manner, the stream processing unit 12 inputs the bits of th_cand1 to the predicate register 1 and masks the operation of each element with the predicate register 1 to add the values input to the SIMD register B to A[0] and A[1]. Then, the stream processing unit 12 finally adds A[0] and A[1] to acquire the computation result of sum computation for the attribute column Y₁.

When the stream ID is “2”, the stream processing unit 12 inputs the bits placed in th_cand2 to a predicate register 2 by the number of SIMD elements (here, two) at a time. Then, the stream processing unit 12 adds the SIMD registers C and B such that the operations of the elements for which the bits of th_cand2 indicate “0” are masked and the operations of the elements for which the bits of th_cand2 has “1” are performed. The SIMD register C is the register on the added side. Here, since “1, 0” is input to the predicate register 2 at the first time, the stream processing unit 12 conducts computation as C[0]=C[0]+B[0] (=19) and C[1]=C[1] (=0). Since “0, 1” is input to the predicate register 2 at the second time, the stream processing unit 12 conducts computation as C[0]=C[0] (=19) and C[1]=C[1]+B[1] (=15). In this manner, the stream processing unit 12 inputs the bits of th_cand2 to the predicate register 2 and masks the operation of each element with the predicate register 2 to add the values input to the SIMD register B to C[0] and C[1]. Then, the stream processing unit 12 finally adds C[0] and C[1] to acquire the computation result of sum computation for the attribute column Y₁.

This allows the stream processing unit 12 to lessen the number of times of loading the attribute column Yₘ to be loaded into the SIMD register B. In addition, the stream processing unit 12 may simultaneously conduct the stream process for a plurality of combinations of conditions and thus may conduct the sum computation for a plurality of combinations of conditions by loading the attribute column Yₘ once.

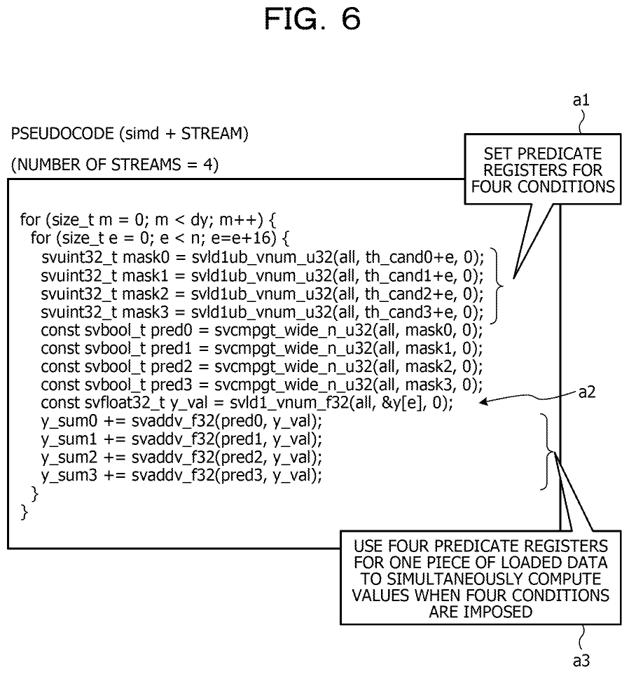

FIG. 6 is a diagram illustrating an example of a pseudocode for sum computation in the stream process according to the embodiment. Note that the pseudocode is a code for SIMD conversion by ACLE for ARM. In FIG. 6, it is assumed that the number of streams is “4”. In addition, a case where the processing target sample data is of float type (32 bits) and the SIMD width is 512 bits is assumed. This means that the number of SIMD elements is “16”. The bit strings corresponding to the four combination conditions are denoted by th_cand0 to th_cand3, which are arrays for placing a bit string in which “1” is set if each condition is satisfied and “0” is set if each condition is not satisfied, for each of the n pieces of sample data included in the observed value list 21. The array of values of the attribute column Yₘ to be added is denoted by y_val. The arrays of values on the added side corresponding to the four combination conditions are denoted by y_sum0 to y_sum3.

The stream processing unit 12 performs the following processing for one attribute Yₘ by the number of SIMD elements (here, “16”) at a time. The stream processing unit 12 sets 16-bit strings of th_cand0 to th_cand3 in predicate registers pred0 to pred3 for the four combination conditions, respectively (a1). The stream processing unit 12 loads 16 attribute values of the attribute Yₘ into y_val (the SIMD register B in FIG. 5) (a2). Then, for the loaded single attribute value group of the attribute Yₘ, the stream processing unit 12 uses the four predicate registers pred0 to pred3 to simultaneously perform sum computation for the four combination conditions (a3).

This allows the stream processing unit 12 to conduct the stream process for a number of sum computations equal to the number of streams, by loading the attribute values corresponding to the attribute Yₘ into a memory once. As a result, the stream processing unit 12 may reduce the number of loop rotations and the number of memory accesses to 1/the number of streams, compared with the case where SIMD processing is available but no stream process is available (refer to FIG. 3). Note that the stream process illustrated in FIG. 6 relates to an example of sum computation but may also be applied to the correlation coefficient calculation process including th_cand computation for generating th_cand.

[Description of Unrolling Process]

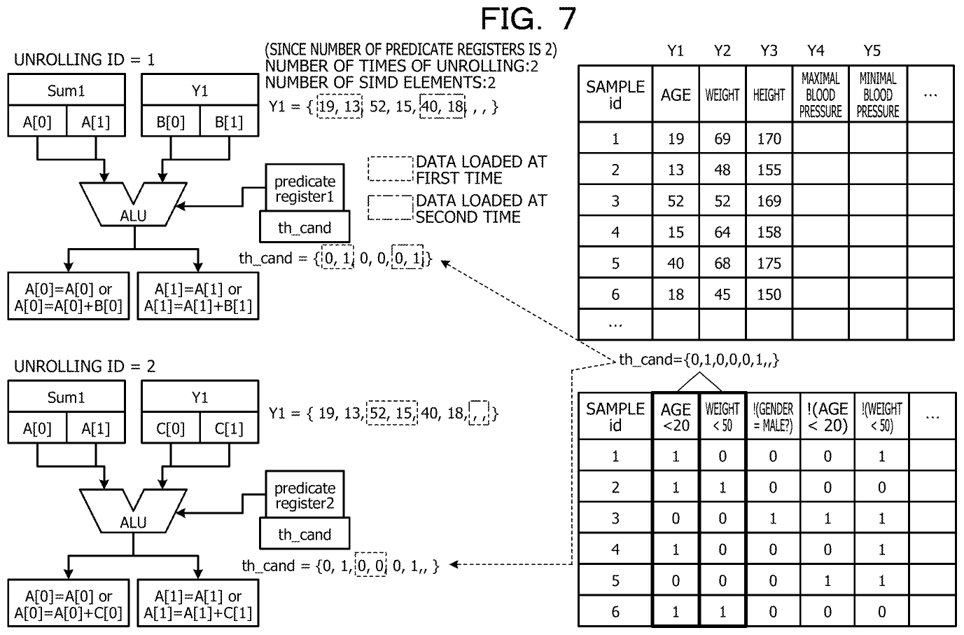

Here, the unrolling process performed by the unrolling processing unit 13 will be described with reference to FIG. 7. FIG. 7 is a diagram illustrating an image of the unrolling process according to the embodiment. Note that, in FIG. 7, it is assumed that the number of streams is “2” and the number of times of unrolling is “2”.

When the unrolling ID is “1”, the combination of conditions is “(age<20) and (weight<50)” indicating the logical product of “age<20” and “weight<50”. The bit string for the combination condition indicated by th_cand is {0, 1, 0, 0, 0, 1, . . . }. When the unrolling ID is “2”, the combination of conditions is the same as when the unrolling ID is “1”. The bit string for the combination condition indicated by th_cand is also the same as when the unrolling ID is “1”.

A case where the unrolling processing unit 13 performs sum computation for the attribute column Y₁ for one combination of conditions under such circumstances will be described. The unrolling processing unit 13 uses two predicate registers to perform sum computation with IDs “1” and “2” in parallel and finally aggregates the computation results to perform sum computation for the attribute column Y₁.

For example, when the unrolling ID is “1”, the unrolling processing unit 13 inputs the bits placed in th_cand to a predicate register 1 by the number of SIMD elements (here, two) at a time. In addition, the unrolling processing unit 13 inputs the values placed in Y₁ to the SIMD register B by the number of SIMD elements (here, two). Then, the unrolling processing unit 13 adds the SIMD registers A and B such that the operations of the elements for which the bits of th_cand indicate “0” are masked and the operations of the elements for which the bits of th_cand indicate “1” are performed. The SIMD register A is the register on the added side. Here, since “0, 1” is input to the predicate register 1 at the first time, the unrolling processing unit 13 conducts computation as A[0]=A[0] (=0) and A[1]=A[1]+B[1] (=13). Since “0, 1” is input to the predicate register 1 at the second time, the unrolling processing unit 13 conducts computation as A[0]=A[0] (=0) and A[1]=A[1]+B[1] (=31). In this manner, the unrolling processing unit 13 inputs the bits of th_cand to the predicate register 1 and masks the operation of each element with the predicate register 1 to add the values input to the SIMD register B to A[0] and A[1].

When the unrolling ID is “2”, the unrolling processing unit 13 inputs the bits placed in th_cand to a predicate register 2 by starting from the place following the bits processed with the unrolling ID “1”, by the number of SIMD elements (here, two) at a time. The unrolling processing unit 13 also inputs the values placed in Y₁ to the SIMD register C by starting from the place following the bits processed with the unrolling ID “1”, by the number of SIMD elements (here, two). Then, the unrolling processing unit 13 adds the SIMD registers A and C such that the operations of the elements for which the bits of th_cand indicate “0” are masked and the operations of the elements for which the bits of th_cand indicate “1” are performed. The SIMD register A is the register on the added side. Here, since “0, 0” is input to the predicate register 2 at the first time, the unrolling processing unit 13 conducts computation as A[0]=A[0] (=0) and A[1]=A[1] (=15). In this manner, the unrolling processing unit 13 inputs the bits of th_cand to the predicate register 2 and masks the operation of each element with the predicate register 2 to add the values input to the SIMD register C to A[0] and A[1]. Then, the unrolling processing unit 13 finally adds A[0] and A[1] to acquire the computation result of sum computation for the attribute column Y₁.

This allows the unrolling processing unit 13 to speed up sum computation by unrolling when the number of remaining combinations of conditions becomes smaller than the number of streams, by using a surplus predicate register.

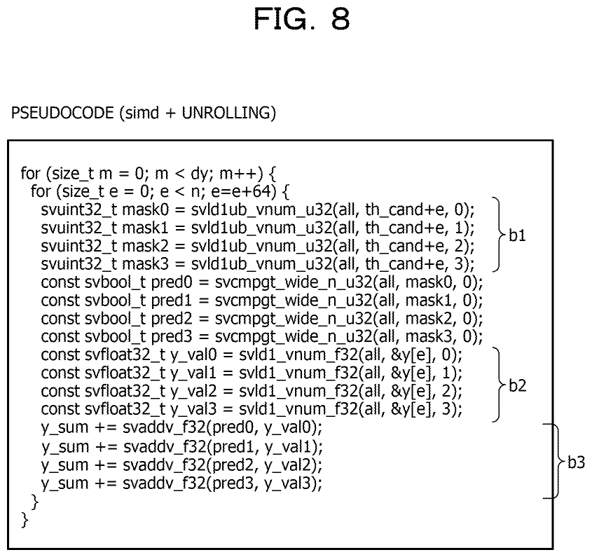

FIG. 8 is a diagram illustrating an example of a pseudocode for sum computation in the unrolling process according to the embodiment. Note that the pseudocode is a code for SIMD conversion by ACLE for ARM. In FIG. 8, it is assumed that the number of times of unrolling is “4”. In addition, a case where the processing target sample data is of float type (32 bits) and the SIMD width is 512 bits is assumed. This means that the number of SIMD elements is “16”. The bit string corresponding to one combination condition is denoted by th_cand, which is an array for placing a bit string in which “1” is set if the combination condition is satisfied and “0” is set if the combination condition is not satisfied, for each of the n pieces of sample data included in the observed value list 21. The arrays of values of the attribute column Yₘ to be added are denoted by y_val0 to y_val3. The array of values on the added side corresponding to the one combination condition is denoted by y_sum.

The unrolling processing unit 13 performs the following processing for one attribute Yₘ by the number of SIMD elements (here, “16”) at a time. The unrolling processing unit 13 sets the 16-bit string of th_cand in each of predicate registers pred0 to pred3 for the one combination condition (b1). The unrolling processing unit 13 loads 16 attribute values of the attribute Yₘ into each of y_val0 to y_val3 (the SIMD registers B and C in FIG. 7) (b2). Then, the unrolling processing unit 13 uses the predicate register pred0 on y_val0 to simultaneously perform sum computation for the one combination condition. The unrolling processing unit 13 uses the predicate register pred1 on y_val1 to simultaneously perform sum computation for the one combination condition. The unrolling processing unit 13 uses the predicate register pred2 on y_val2 to simultaneously perform sum computation for the one combination condition. The unrolling processing unit 13 uses the predicate register pred3 on y_val3 to simultaneously perform sum computation for the one combination condition (b3). The results of the sum computation are set in y_sum.

This allows the unrolling processing unit 13 to speed up sum computation by processing the sum computation for one combination condition by unrolling using a surplus predicate register. In addition, since instructions to compute the loop count and jump instructions that are executed in every loop rotation may be reduced because of a decrease in the number of loop rotations, the unrolling processing unit 13 may speed up sum computation compared with the case where the SIMD processing is available but no unrolling process is available (refer to FIG. 3). Note that the unrolling process illustrated in FIG. 8 relates to an example of sum computation but may also be applied to the correlation coefficient calculation process including th_cand computation for generating th_cand.

[Flowchart of Search Process]

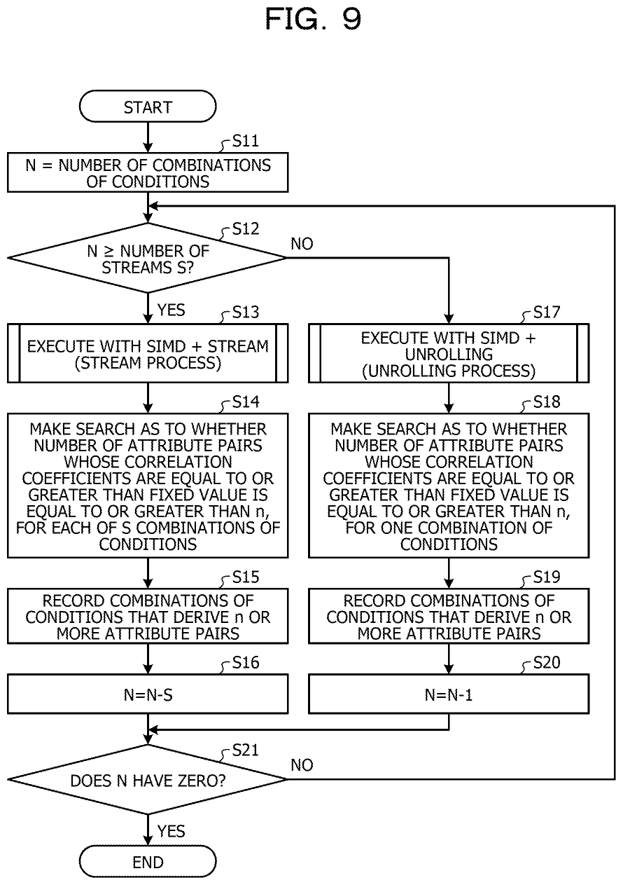

FIG. 9 is a diagram illustrating an example of a flowchart of the search process according to the embodiment.

The determination unit 11 sets the number of combinations of conditions in a variable N (step S11). For example, when the number of all conditions is assumed as dx and the number of conditions to be combined is assumed as k, the value set in the variable N is _{dx}Cₖ.

The determination unit 11 determines whether or not the variable N is equal to or greater than the number of streams S (step S12). When it is determined that the variable N is equal to or greater than the number of streams S (step S12; Yes), the stream processing unit 12 performs processing with SIMD+stream (stream process) (step S13). Note that a flowchart of the stream process will be described later.

Then, the stream processing unit 12 makes a search as to whether the number of attribute pairs whose correlation coefficients are equal to or greater than a fixed value is equal to or greater than n, for each of S combinations of conditions (step S14). The stream processing unit 12 then records the combinations of conditions that derive n or more attribute pairs having correlation coefficients equal to or greater than the fixed value (step S15).

Then, the determination unit 11 sets the number obtained by subtracting the number of streams S from the variable N in the variable N (step S16). The determination unit 11 then proceeds to step S21.

On the other hand, when it is determined that the variable N is less than the number of streams S (step S12; No), the unrolling processing unit 13 performs processing with SIMD+unrolling (unrolling process) (step S17). Note that a flowchart of the unrolling process will be described later.

Then, the unrolling processing unit 13 makes a search as to whether the number of attribute pairs whose correlation coefficients are equal to or greater than the fixed value is equal to or greater than n, for one combination of conditions (step S18). The unrolling processing unit 13 then records the combination of conditions that derives n or more attribute pairs having correlation coefficients equal to or greater than the fixed value (step S19).

Then, the determination unit 11 sets the number obtained by subtracting “1” from the variable N in the variable N (step S20). The determination unit 11 then proceeds to step S21.

In step S21, the determination unit 11 determines whether or not the variable N has zero (step S21). When determining that the variable N does not have zero (step S21; No), the determination unit 11 proceeds to step S12.

On the other hand, when determining that the variable N has zero (step S21; Yes), the determination unit 11 terminates the search process.

[Flowchart of Stream Process]

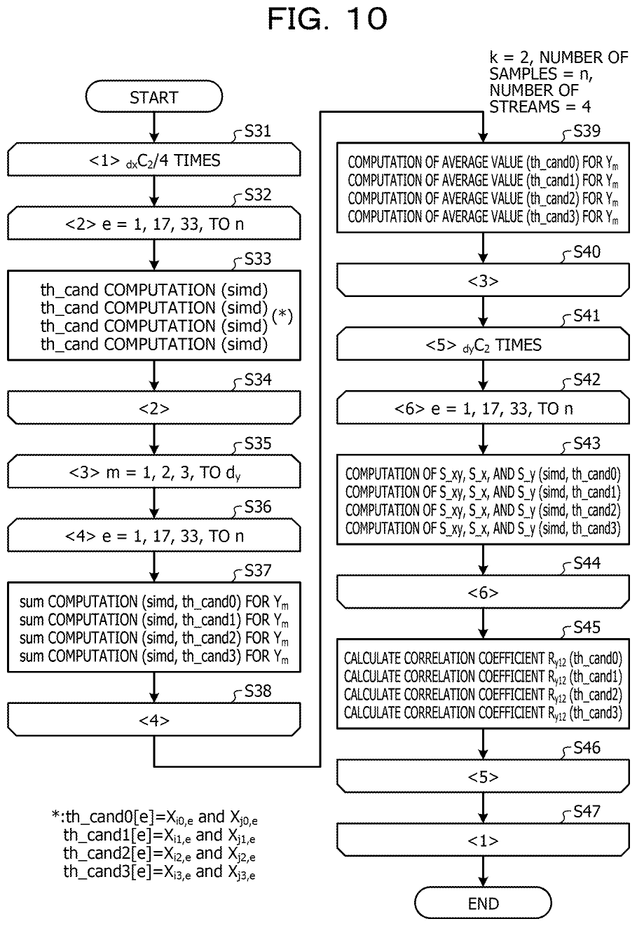

FIG. 10 is a diagram illustrating an example of a flowchart of the correlation coefficient calculation process when the stream process according to the embodiment is applied. Note that the number of streams is assumed to be “4”. The number of all conditions is assumed as dx. The number of conditions k to be combined is assumed to be “2”. The total number of sample ids is assumed as n. The number of attribute columns is assumed as d_{y}. In addition, a case where the data type of the sample data is the float type (32 bits) and the SIMD width is 512 bits is assumed.

As illustrated in FIG. 10, the stream processing unit 12 repeats the processing in steps S32 to S47 _{dx}C₂/4 times (step S31). For example, the stream processing unit 12 selects four combinations of conditions and carries out the processing in steps S32 to S47 for the selected four combinations of conditions.

The stream processing unit 12 repeats steps S33 and S34 with an increment value of 16 until the index e of the th_cand array has the total number of sample ids n starting from one (step S32). The stream processing unit 12 performs the th_cand computation (simd) process (step S33). For example, the stream processing unit 12 computes “X_{i0,e} and X_{j0,e}” for each of the indices e to e+15 for the first selected combination of conditions and sets the computed result in th_cand0[e]. Here mentioned X_{i0,e} and X_{j0,e} indicate bits of the index e for conditions Xᵢ₀ and Xⱼ₀. The stream processing unit 12 similarly computes the second to fourth selected combinations of conditions and sets the computed results in th_cand1[e], th_cand2[e], and th_cand3[e]. The correlation coefficient calculation process proceeds to step S32 to process the next index e (step S34).

Subsequently, the stream processing unit 12 repeats steps S36 to S40 until the index m indicating the attribute has the number of attribute columns d_{y} starting from one (step S35). Then, the stream processing unit 12 repeats steps S37 and S38 with an increment value of 16 until the index e has the total number of sample ids n starting from one (step S36). The stream processing unit 12 performs sum computation (simd, th_cand0), sum computation (simd, th_cand1), sum computation (simd, th_cand2), and sum computation (simd, th_cand3) for the attribute column Yₘ (step S37). For example, for the first selected combination of conditions, the stream processing unit 12 performs addition of the attribute column Yₘ that satisfies the condition (th_cand0[e]=“1”), by 16 pieces at a time, and computes the total (sum0) by adding each value of the indices e to e+15. Also for the second to fourth selected combinations of conditions, the stream processing unit 12 computes the total (sum1 to sum3) by similarly adding. The stream processing unit 12 proceeds to step S36 to process the next index e (step S38).

Subsequently, the stream processing unit 12 computes the average values of the attribute column Yₘ for each of the selected four combinations of conditions (step S39). Then, the stream processing unit 12 proceeds to step S35 to process the next attribute (step S40).

Subsequently, the stream processing unit 12 takes out two attribute columns from among all attribute columns and repeats the processing in steps S42 to S46 _{dy}C₂ times (step S41). The stream processing unit 12 repeats steps S43 and S44 with an increment value of 16 until the index e of the th_cand array has the total number of sample ids n starting from one (step S42). The stream processing unit 12 performs computation of S_xy, S_x, and S_y (simd, th_cand0), computation of S_xy, S_x, and S_y (simd, th_cand1), computation of S_xy, S_x, and S_y (simd, th_cand2), and computation of S_xy, S_x, and S_y (simd, th_cand3) (step S43). For example, for the first selected combination of conditions, the stream processing unit 12 uses the values of the indices e to e+15 of the attribute column Yₘ that satisfy the condition (th_cand0[e]=“1”) to compute S_xy, S_x, and S_y. Formula (1) corresponds to S_xy here mentioned. Formula (2) corresponds to S_x. Formula (3) corresponds to S_y. The stream processing unit 12 similarly compute also the second to fourth selected combinations of conditions. Then, the stream processing unit 12 proceeds to step S42 to process the next index e (step S44).

Subsequently, the stream processing unit 12 calculates the correlation coefficients R_{y12} between the two attribute columns that have been taken out, for each of the selected four combinations of conditions (step S45). Formula (4) corresponds to R_{y12} here mentioned. Then, the correlation coefficient calculation process proceeds to step S41 to take out next two attribute columns (step S46).

The stream processing unit 12 then proceeds to step S31 to select four combinations of conditions (step S47).

This allows the stream processing unit 12 to reduce the number of loop rotations to 1/the number of streams (<1>) compared with the case where the SIMD processing is available but no stream process is available (refer to FIG. 3), by performing the correlation coefficient calculation process in parallel for a number of combinations of conditions equal to the number of streams. As a result, the stream processing unit 12 may speed up the search process.

[Flowchart of Unrolling Process]

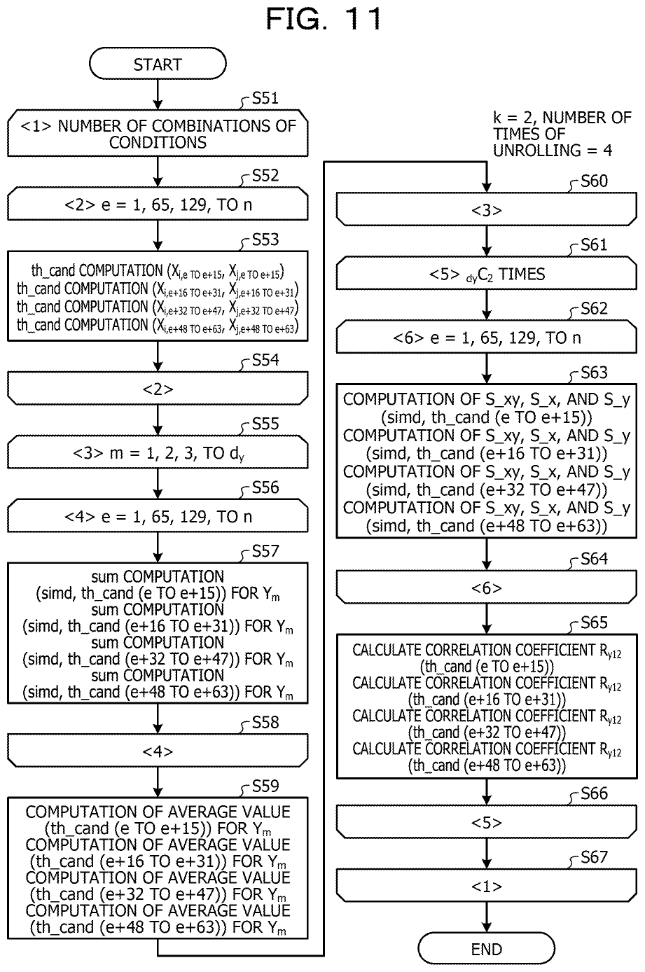

FIG. 11 is a diagram illustrating an example of a flowchart of the correlation coefficient calculation process when the unrolling process according to the embodiment is applied. Note that the number of times of unrolling is assumed to be “4”. The number of conditions k to be combined is assumed to be “2”. The total number of sample ids is assumed as n. The number of attribute columns is assumed as d_{y}. In addition, a case where the data type of the sample data is the float type (32 bits) and the SIMD width is 512 bits is assumed.

As illustrated in FIG. 11, the unrolling processing unit 13 repeats the processing in steps S52 to S67 once for one combination of conditions (step S51).

The unrolling processing unit 13 repeats steps S53 and S54 with an increment value of 64 until the index e of the th_cand array has the total number of sample ids n starting from one (step S52). The unrolling processing unit 13 performs th_cand computation (step S53). For example, for one combination of conditions, the unrolling processing unit 13 performs the following computation in units of 16 pieces of sample data. The unrolling processing unit 13 computes “X_{i,e to e+15} and X_{j,e to e+15}” for the first 16 pieces of sample data and sets the computed results in th_cand (e to e+15). Here mentioned X_{i,e} and X_{j,e} indicate bits of the index e for the conditions Xᵢ and Xⱼ. The unrolling processing unit 13 similarly computes for the next 16 pieces of sample data and sets the computed results in th_cand (e+16 to e+31), th_cand (e+32 to e+47), th_cand (e+48 to e+63). The unrolling processing unit 13 proceeds to step S52 to process the next index e (step S54).

Subsequently, the unrolling processing unit 13 repeats steps S56 to S60 until the index m indicating the attribute has the number of attribute columns d_{y} starting from one (step S55). Then, the unrolling processing unit 13 repeats steps S57 and S58 with an increment value of 64 until the index e has the total number of sample ids n starting from one (step S56). For the attribute column Yₘ, the unrolling processing unit 13 performs sum computation (simd, th_cand (e to e+15)), sum computation (simd, th_cand (e+16 to e+31)), sum computation (simd, th_cand (e+32 to e+47)), and sum computation (simd, th_cand (e+48 to e+63)) in units of 16 pieces of sample data (step S57). For example, for the first 16 pieces of sample data, the unrolling processing unit 13 performs addition of the attribute column Yₘ that satisfies the condition (th_cand[e]=“1”) and computes the total (sum) by adding each value of the indices e to e+15. The unrolling processing unit 13 computes the total (sum) also for the next 16 pieces of sample data by similarly adding. The unrolling processing unit 13 proceeds to step S56 to process the next index e (step S58).

Subsequently, the unrolling processing unit 13 uses the total (sum) to compute the average values of the attribute column Yₘ (step S59). Then, the unrolling processing unit 13 proceeds to step S55 to process the next attribute (step S60).

Subsequently, the unrolling processing unit 13 takes out two attribute columns from among all attribute columns and repeats the processing in steps S62 to S66 _{dy}C₂ times (step S61). The unrolling processing unit 13 repeats steps S63 and S64 with an increment value of 64 until the index e of the th_cand array has the total number of sample ids n starting from one (step S62). The unrolling processing unit 13 performs computation of S_xy, S_x, and S_y (simd, th_cand (e to e+15)), computation of S_xy, S_x, and S_y (simd, th_cand (e+16 to e+31)), computation of S_xy, S_x, and S_y (simd, th_cand (e+32 to e+47)), and computation of S_xy, S_x, and S_y (simd, th_cand (e+48 to e+63)) (step S63). For example, for the first 16 pieces of sample data, the unrolling processing unit 13 uses the values of indices e to e+15 of the attribute column Yₘ that satisfy the condition (th_cand[e]=“1”) to compute S_xy, S_x, and S_y. Formula (1) corresponds to S_xy here mentioned. Formula (2) corresponds to S_x. Formula (3) corresponds to S_y. The unrolling processing unit 13 similarly computes also the next 16 pieces of sample data. Then, the unrolling processing unit 13 proceeds to step S62 to process the next index e (step S64).

Subsequently, the unrolling processing unit 13 calculates the correlation coefficients R_{y12} between the two attribute columns that have been taken out (step S65). Formula (4) corresponds to R_{y12} here mentioned. Then, the unrolling processing unit 13 proceeds to step S61 to take out next two attribute columns (step S66).

The unrolling processing unit 13 then proceeds to step S51 to take out the next combination of conditions (step S67).

This allows the unrolling processing unit 13 to reduce the number of loop rotations to 1/(16×the number of times of unrolling), compared with the case where only the SIMD processing is available (refer to FIG. 3) because the processing in the loops of the th_cand computation (<2>), the sum computation (<4>), and the correlation coefficient computation (<6>) are performed collectively by 16 pieces of sample data×the number of times of unrolling at a time. That is, since instructions to compute the loop count and jump instructions that are executed in every loop rotation may be reduced by reducing the number of loop rotations, the unrolling processing unit 13 may speed up the search process.

### Effects of Embodiment

According to the above embodiment, in a search for combinations of conditions that allow extraction of sample data groups that have n (n is a natural number) or more attribute pairs whose correlation coefficients exceed a threshold value, if the number of combinations of conditions is equal to or greater than a number capable of being parallelized, the information processing device 1 parallelizes processing for a number of the combinations of the conditions equal to the number capable of being parallelized, in addition to a SIMD conversion process that uses a number of predicate registers equal to the number capable of being parallelized, and calculates the correlation coefficients of a plurality of attribute pairs for each of the combinations of the conditions. Then, the information processing device 1 uses each of the correlation coefficients of the plurality of attribute pairs for each of the combinations of the conditions to search for the combinations of the conditions that derive n or more attribute pairs whose correlation coefficients exceed the threshold value. According to such a configuration, the information processing device 1 may speed up the processing of calculating the correlation coefficients of the attribute pairs, by performing parallelization in addition to the SIMD conversion. As a result, the information processing device 1 may speed up the processing of searching for the combinations of the conditions that derive n or more attribute pairs whose correlation coefficients exceed the threshold value.

In addition, according to the above embodiment, if the number of combinations of conditions is less than the number capable of being parallelized, the information processing device 1 calculates the correlation coefficients of the plurality of attribute pairs for each of the combinations of the conditions, with an unrolling process that unrolls the processing for one combination of the conditions into a plurality of units, in addition to the SIMD conversion process that uses the predicate registers. According to such a configuration, the information processing device 1 may speed up the processing of calculating the correlation coefficients of the attribute pairs, by performing the unrolling process in addition to the SIMD conversion. As a result, the information processing device 1 may speed up the processing of searching for the combinations of the conditions that derive n or more attribute pairs whose correlation coefficients exceed the threshold value.

Note that each illustrated component of the information processing device 1 does not necessarily have to be physically configured as illustrated in the drawings. For example, specific forms of distribution and integration of the information processing device 1 are not limited to the illustrated ones, and the whole or a part of the information processing device 1 may be configured by being functionally or physically distributed and integrated in any units according to various loads, use states, or the like. In addition, the storage unit 20 may be coupled through a network as an external device of the information processing device 1.

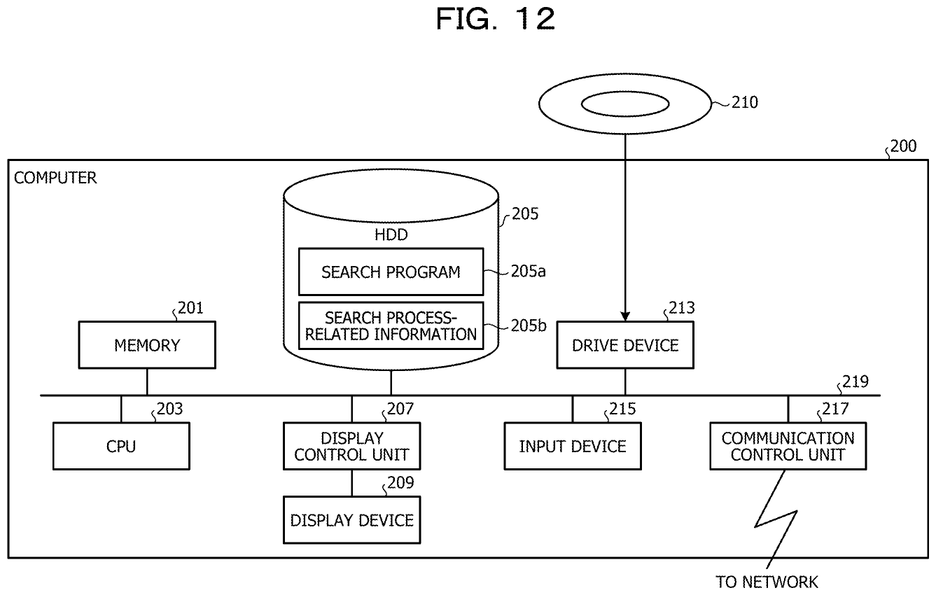

Furthermore, various types of processing described in the above embodiment may be implemented by a computer such as a personal computer or a workstation executing programs prepared in advance. Thus, in the following, an example of a computer that executes a search program implementing functions similar to the functions of the information processing device 1 illustrated in FIG. 1 will be described. FIG. 12 is a diagram illustrating an example of a computer that executes the search program.

As illustrated in FIG. 12, a computer 200 includes a CPU 203 that executes various types of arithmetic processing, an input device 215 that accepts data input from a user, and a display control unit 207 that controls a display device 209. In addition, the computer 200 includes a drive device 213 that reads a program and the like from a storage medium, and a communication control unit 217 that exchanges data with another computer via a network. The computer 200 further includes a memory 201 that temporarily stores various types of information, and a hard disk drive (HDD) 205. Then, the memory 201, the CPU 203, the HDD 205, the display control unit 207, the drive device 213, the input device 215, and the communication control unit 217 are coupled by a bus 219.

The drive device 213 is a device for a removable disk 210, for example. The HDD 205 stores a search program 205a and search process-related information 205b.

The CPU 203 reads the search program 205a to load the read search program 205a into the memory 201 and executes the loaded search program 205a as a process. Such a process corresponds to the respective functional units of the information processing device 1. The search process-related information 205b corresponds to the observed value list 21 and the condition list 22. Then, for example, the removable disk 210 stores each piece of information such as the search program 205a.

Note that the search program 205a does not necessarily have to be stored in the HDD 205 from the beginning. For example, the program is stored in a “portable physical medium” to be inserted into the computer 200, such as a flexible disk (FD), a compact disk read only memory (CD-ROM), a digital versatile disk (DVD), a magneto-optical disk, or an integrated circuit (IC) card. Then, the computer 200 may read the search program 205a from these media and execute the read search program 205a.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
in a search for combinations of conditions that allow extraction of sample data groups that have n (n is a natural number) or more attribute pairs whose correlation coefficients exceed a threshold value, when a number of combinations of the conditions is equal to or greater than a number capable of being parallelized, parallelizing processing for the combinations of the conditions per the number capable of being parallelized to calculate the correlation coefficients of respective attribute pairs for each of the combinations of the conditions in addition to a single instruction multiple data (SIMD) conversion process that uses predicate registers as many as the number capable of being parallelized; and
searching for the combinations of conditions using the correlation coefficients of the respective attribute pairs for each of the combinations of the conditions.

2. The non-transitory computer-readable recording medium according to claim 1, the process further comprising:
when the number of the combinations of the conditions is less than the number capable of being parallelized, calculating the correlation coefficients of the respective attribute pairs for each of the combinations of the conditions, with an unrolling process that unrolls processing for one combination of the conditions into a plurality of units in addition to the SIMD conversion process that uses the predicate registers.

3. An information processing device, comprising:
a memory; and
a processor coupled to the memory and the processor configured to:
in a search for combinations of conditions that allow extraction of sample data groups that have n (n is a natural number) or more attribute pairs whose correlation coefficients exceed a threshold value, when a number of combinations of the conditions is equal to or greater than a number capable of being parallelized, parallelize processing for the combinations of the conditions per the number capable of being parallelized to calculate the correlation coefficients of respective attribute pairs for each of the combinations of the conditions in addition to a single instruction multiple data (SIMD) conversion process that uses predicate registers as many as the number capable of being parallelized; and
search for the combinations of conditions using the correlation coefficients of the respective attribute pairs for each of the combinations of the conditions.

4. A search method, comprising:
in a search for combinations of conditions that allow extraction of sample data groups that have n (n is a natural number) or more attribute pairs whose correlation coefficients exceed a threshold value, when a number of combinations of the conditions is equal to or greater than a number capable of being parallelized, parallelizing, by a computer, processing for the combinations of the conditions per the number capable of being parallelized to calculate the correlation coefficients of respective attribute pairs for each of the combinations of the conditions in addition to a single instruction multiple data (SIMD) conversion process that uses predicate registers as many as the number capable of being parallelized; and
searching for the combinations of conditions using the correlation coefficients of the respective attribute pairs for each of the combinations of the conditions.
